(19) United States
(12) Patent Application Publication
(10) Pub. No.: US 2011/0142400 A1
(43) Pub. Date: Jun. 16, 2011

(54) CABLE ASSEMBLY HAVING FLOATABLE OPTICAL MODULE

(75) Inventors: TERRANCE F. LITTLE, York, PA (US); JAMES M. SABO, Harrisburg, PA (US)

(73) Assignee: HON HAI PRECISION INDUSTRY CO., LTD., Tu-Cheng (TW)

(21) Appl. No.: 12/636,774

(22) Filed: Dec. 13, 2009

(51) Int. Cl. G02B 6/36; G02B 6/44

(52) U.S. Cl. 385/77; 385/100

(57) ABSTRACT

A cable assembly (100) includes an insulative housing (2) defining a mounting cavity (221) along a front-to-back direction; an optical module (5) accommodated in the mounting cavity; at least one fiber (6) extending into the mounting cavity and coupled to the optical module; two kicker springs (9) mounted to the insulated housing spaced away from each other along a transversal direction perpendicular to the front-to-back direction, the two kicker springs (9) located behind the optical module to bias the optical module.

### CROSS-REFERENCE TO RELATED APPLICATIONS

This application is related to U.S. patent application Ser. No. 11/818,100, filed on Jun. 13, 2007 and entitled “EXTENSION TO UNIVERSAL SERIAL BUS CONNECTOR WITH IMPROVED CONTACT ARRANGEMENT”, and U.S. patent application Ser. No. 11/982,660, filed on Nov. 2, 2007 and entitled “EXTENSION TO ELECTRICAL CONNECTOR WITH IMPROVED CONTACT ARRANGEMENT AND METHOD OF ASSEMBLING THE SAME”, and U.S. patent application Ser. No. 11/985,676, filed on Nov. 16, 2007 and entitled “ELECTRICAL CONNECTOR WITH IMPROVED WIRE TERMINATION”, and U.S. patent application Ser. No. 12/626,632 filed on Nov. 26, 2009 and entitled “CABLE ASSEMBLY HAVING POSITIONING MEANS SECURING”, and U.S. patent application Ser. No. 12/626,631 filed Nov. 26, 2009 and entitled “CABLE ASSEMBLY HAVING POSITIONING MEANS SECURING FIBER THEREOF”, and a copending application having the same filing date ad the same title with the invention, all of which have the same assignee as the present invention.

### BACKGROUND OF THE INVENTION

1. Field of the Invention

The present invention relates to a cable assembly, more particularly to a cable assembly capable of transmitting optical signal.

2. Description of Related Art

Recently, personal computers (PC) are used of a variety of techniques for providing input and output. Universal Serial Bus (USB) is a serial bus standard to the PC architecture with a focus on computer telephony interface, consumer and productivity applications. The design of USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connectors and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a kind of connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, optical lenses are unable to being floatable with regard to the housing, and they are not accurately and aligned with and optically coupled to counterparts, if there are some errors in manufacturing process.

### BRIEF SUMMARY OF THE INVENTION

Accordingly, an object of the present invention is to provide a cable assembly has a floatable optical module.

In order to achieve the above-mentioned object, a cable assembly in accordance with present invention comprises an insulative housing defining a mounting cavity along a front-to-back direction; an optical module accommodated in the mounting cavity; at least one fiber extending into the mounting cavity and coupled to the optical module; two kicker springs mounted to the insulated housing spaced away from each other along a transversal direction perpendicular to the front-to-back direction, the two kicker springs located behind the optical module to bias the optical module.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a cable assembly in accordance with the first embodiment of the present invention;

FIG. 2 is an exploded, perspective view of FIG. 1;

FIG. 3 is similar to FIG. 2, but viewed from another aspect;

FIG. 4 is a partially assembled view of the cable assembly;

FIG. 5 is other partially assembly view of the cable assembly;

FIG. 6 is a partially assembled view of the cable assembly in accordance with the second embodiment of the present invention;

FIG. 7 is an exploded, perspective view of FIG. 6; and

FIG. 8 is other exploded, perspective view of FIG. 6.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

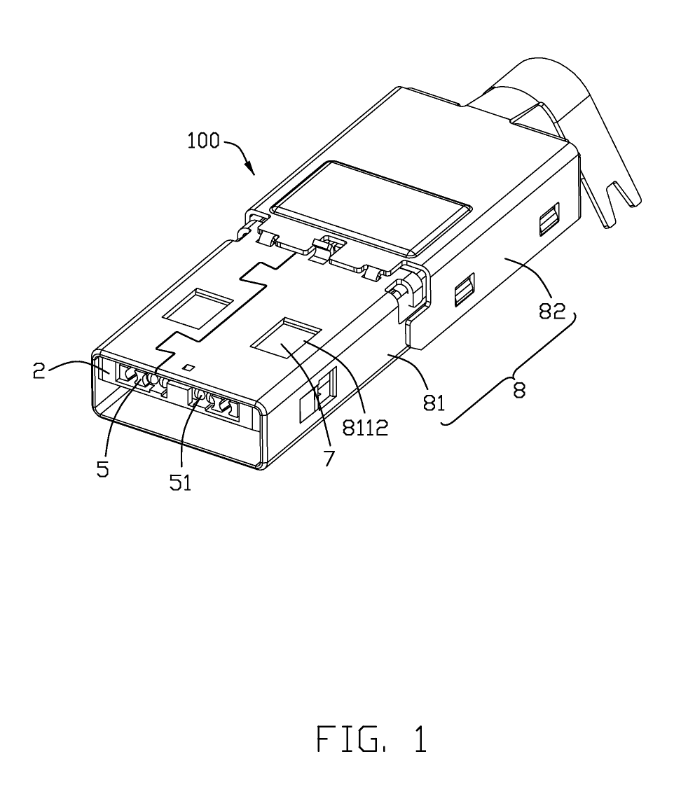

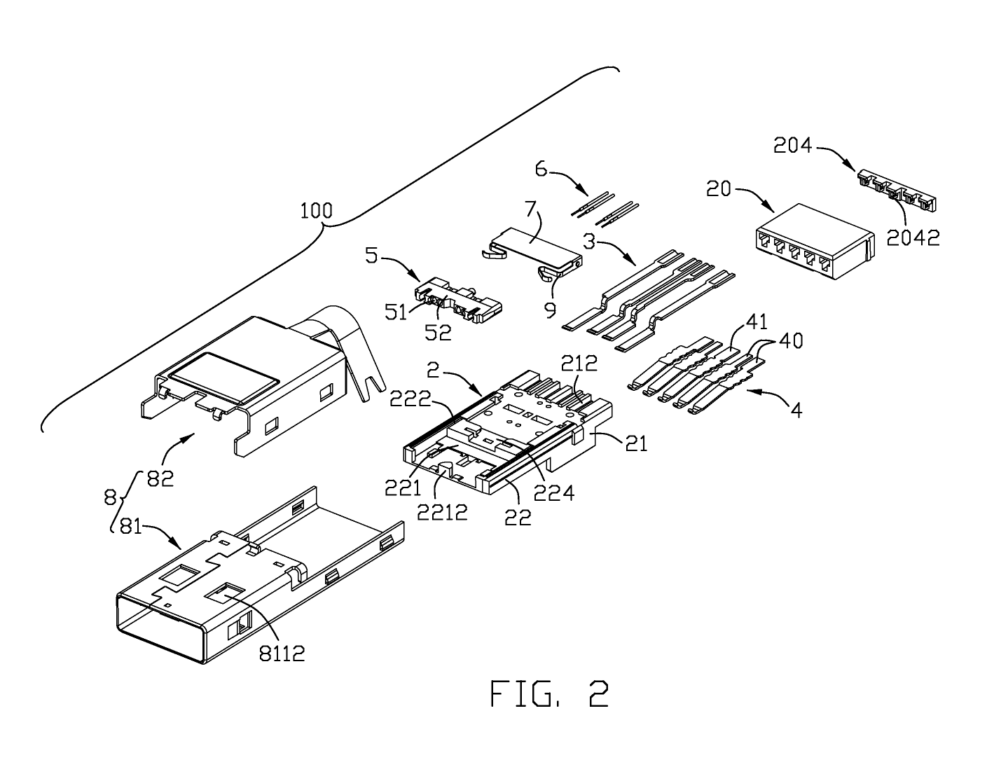

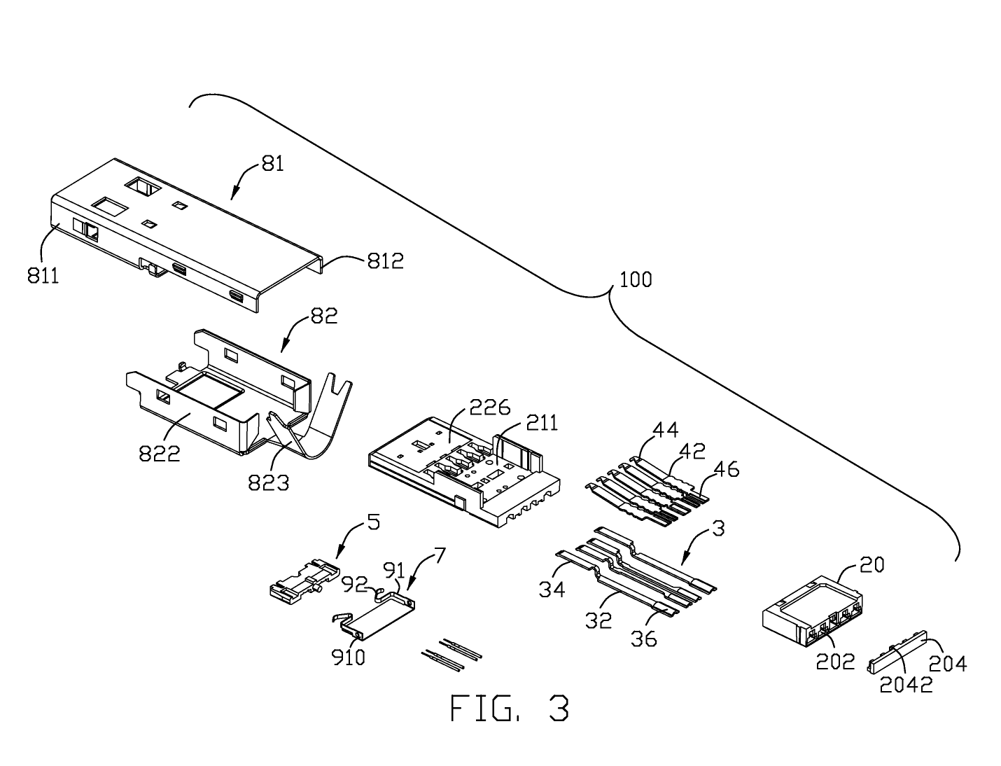

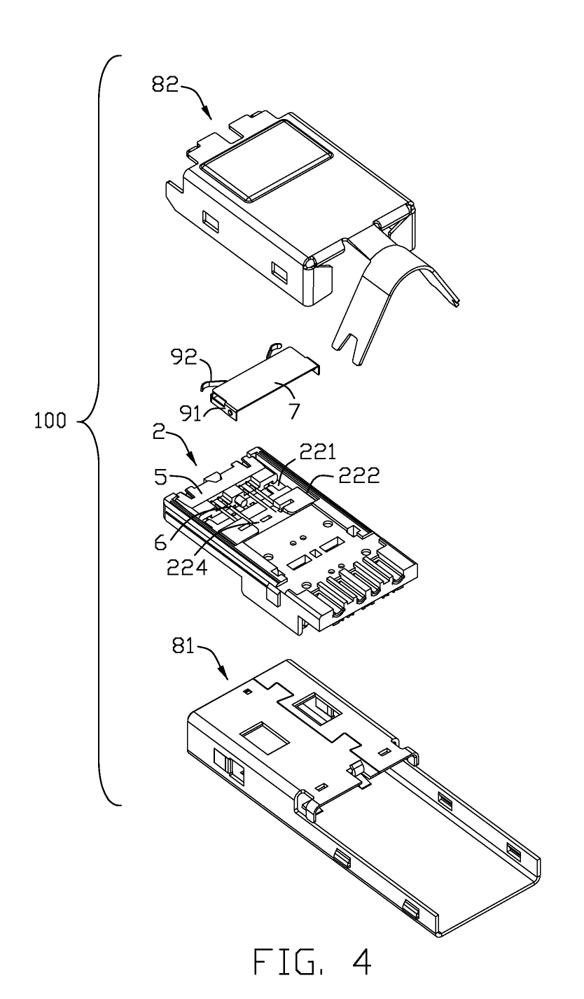

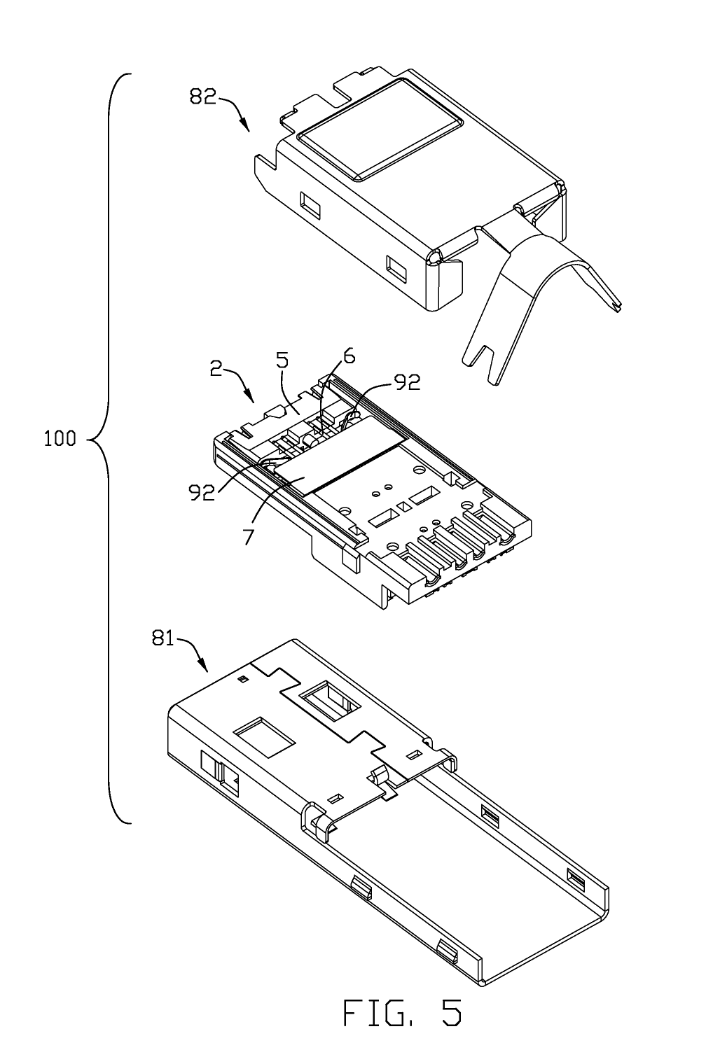

Referring to FIGS. 1-5, a cable assembly 100 according to the first embodiment of the present invention is disclosed. The cable assembly 100 comprises an elongated insulative housing 2 extending along a front-to-back direction, a set of first contacts 3, a set of second contacts 4 and a optical modules 5 supported by the insulative housing 2, and a number of fibers 6 coupled to the optical module 5. The cable assembly 1 further comprises a cap member 7, a metal shell 8 and two kicker springs 9 spaced apart from each other along a transversal direction perpendicular to the front-to-back direction. The kicker springs 9 are capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22 and the base portion 21. A stopping member 2212 is formed in a front portion of the mounting cavity 221. A pair of positioning slots 222 are defined in lateral sides of a middle segment of the mounting cavity 221 and located within the mounting cavity 221. A depression 224 is defined in a middle portion of the tongue portion 22 and located within the mounting cavity 221. A number of contact slots 212 are defined in an upper segment of a rear portion of the base portion 21.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depression 226 of the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each signal contact 4 includes a planar retention portion 42 received in corresponding groove 202 in the insulator 20, a curved mating portion 44 extending forward from the retention portion 42 and disposed beyond a front surface of the insulator 20, and a tail portion 46 extending rearward from the retention portion 42 and disposed behind a back surface of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and pressed onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in a front segment of the corresponding mounting cavity 221.

The cap member 7 and the two kicker springs 9 are stamped from a metallic sheet. The cap member 7 is a planar part. Each kicker spring 9 has a mounting arm 91 connected to a lateral edge of a rear segment of the cap member 7, a curved elastic arm 92 connected to a front end of the mounting arm 91. The kicker spring 92 is arranged in cantilevered manner with regard to the cap member 91. The kicker spring 9 is disposed below the cap member 7, with the elastic arm 92 disposed in front of the cap member 7. The elastic arm 92 is of V-shaped contour and extends inwardly. The cap member 7 is mounted to the insulative housing 1 and covers the depression 224. The mounting arm 91 of the kicker spring 9 is inserted into the corresponding positioning slot 222 and the elastic arm 92 is disposed in the front segment of the mounting cavity 221 to exert a forward force to the optical module 5. Therefore, the optical module 5 is capable of moving backwardly and forwardly within the mounting cavity 221. A barb/protrusion 910 is formed on the mounting arm 91 to increase combination between the kicker spring 91 and the insulative housing 2.

Four fibers 6 are separated into two groups and enter a rear section of the mounting cavity 221, through the depression 224 and are coupled to the four lens 51, respectively. The fibers 6 are confined in the passage between the cap member 7 and the depression 224, so they are unable to drift freely in the mounting cavity 221.

The metal shell 8 comprises a first shield part 81 and a second shield part 82. The first shield part 81 includes a front tube-shaped mating frame 811, a rear U-shaped body section 812 connected to a bottom side and lateral sides of the mating frame 811. The mating frame 811 further has two windows 8112 defined in a top side thereof. The second shield part 82 includes an inverted U-shaped body section 822, and a cable holder member 823 attached to a top side of the body section 822.

The insulative housing 2 is assembled to the first shield part 81, with the tongue portion 22 enclosed in the mating frame 811, the cap member 7 arranged underneath the windows 811, and the base portion 21 is received in the body portion 812. The second shield part 82 is assembled to the first shield part 81, with body portions 822, 812 combined together. The cable assembly may have a hybrid cable which includes fibers 6 for transmitting optical signals and copper wires (not shown) for transmitting electrical signals. The copper wires are terminated to the first contacts 3 and the second contacts 4. The cable holder member 823 is crimped onto the cable to enhance mechanical interconnection.

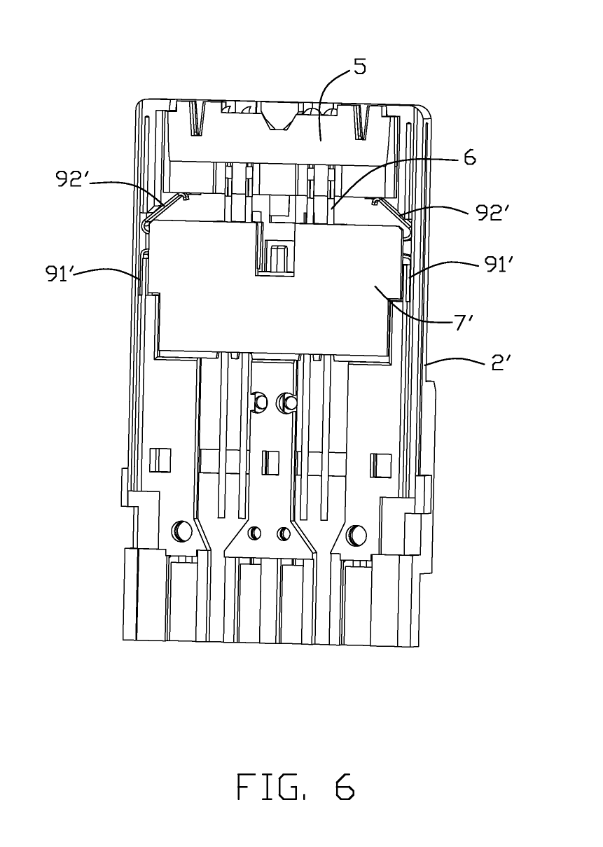

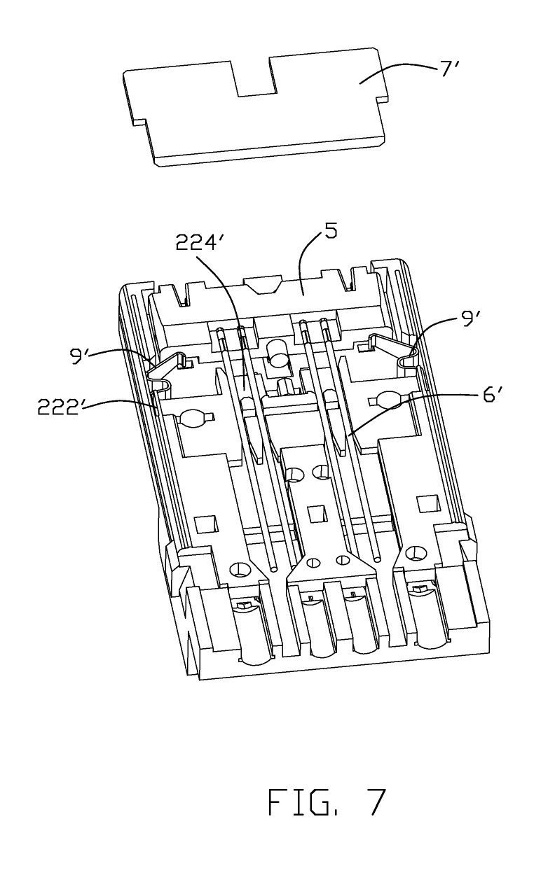

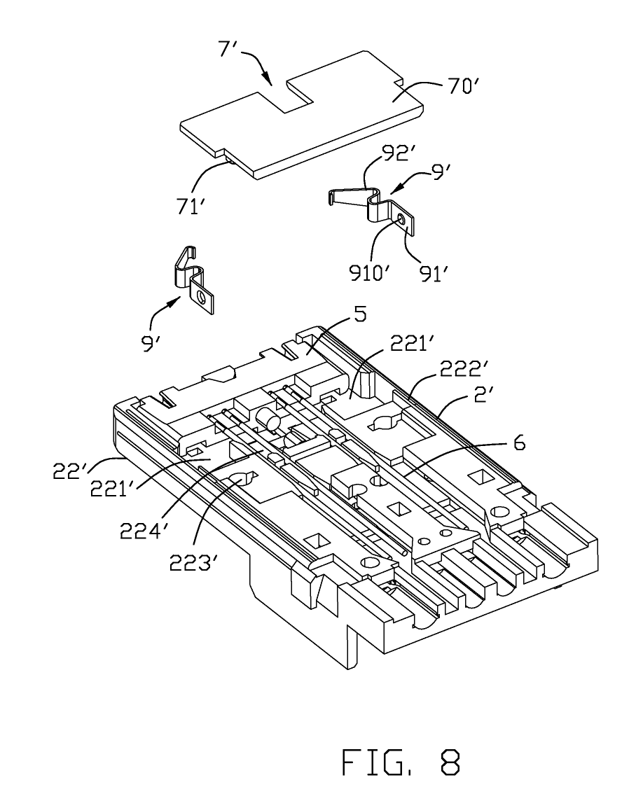

Referring to FIGS. 6-10, a cable assembly according to the second embodiment of the present invention is disclosed. The cable assembly of the second embodiment is similar with the cable assembly 100 of the first embodiment, except for a cap member 7′, two kicker springs 9′ and an insulative housing 2′. The cap member 7′ has a body portion 70′ and two crush posts 72′ formed on a bottom surface of the body portion 70′. The insualtive housing 2′ has two depressions 224′ arranged in parallel relations, and fibers 6 separated into two groups and coupled to optical module 5 via the two depressions 224. Each kicker spring 9′ has a mounting arm 91′ and a zigzag shaped elastic arm 92′ connected to a front end of the mounting arm 91′. The mounting arm 91′ is inserted into a corresponding positioning slot 222′ defined in a lateral side of a tongue portion 22′. The elastic arm 92′ further projects inwardly and into a front portion of a mounting cavity 221′. The optical module 5 is accommodated in the front portion of the mounting cavity 221′ and can be biased forwardly moving by the elastic arm 92′. The cap member 7′ is assembled to the insulative housing 1, with the body portion 70′ shielding the two depressions 224′ and partial of the two elastic arms 92′. The two crush posts 72′ engage with positioning holes 223′ defined in the tongue portion 22′. The mounting arm 91′ also has a protrusion/barb 910′ formed thereon to increase engagement between the kicker spring 9 and the insulative housing 2′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. A cable assembly, comprising:
an insulative housing defining a mounting cavity along a front-to-back direction;
an optical module accommodated in the mounting cavity;
at least one fiber extending into the mounting cavity and coupled to the optical module;
two kicker springs mounted to the insulated housing spaced away from each other along a transversal direction perpendicular to the front-to-back direction, and the two kicker springs located behind the optical module to bias the optical module.

2. The cable assembly as claimed in claim 1, wherein each of the two kicker springs has a mounting arm inserted into a positioning slot defined in a lateral side of the insulative housing, and an elastic arm connected with the mounting arm and presses onto the optical module.

3. The cable assembly as claimed in claim 2, wherein a cap member is assembled to the insulative housing and covers the at least one fiber.

4. The cable assembly as claimed in claim 3, wherein the two kicker springs respectively connect with lateral sides of the cap member.

5. The cable assembly as claimed in claim 4, wherein the two kicker springs are disposed below the cover.

6. The cable assembly as claimed in claim 4, wherein the elastic arms of the two kicker springs are disposed in front of the cover.

7. The cable assembly as claimed in claim 4, wherein the elastic arm deflects inwardly relative to the mounting arm.

8. The cable assembly as claimed in claim 7, wherein the elastic arm is configured to V-shaped contour.

9. The cable assembly as claimed in claim 2, wherein a cap member is assembled to the insulative housing and partially covers the two kicker springs.

10. The cable assembly as claimed in claim 9, wherein the cap member has two crush posts engaging with positioning holes defined in the insulative housing.

11. The cable assembly as claimed in claim 2, wherein the elastic arm is zigzag shape.

12. The cable assembly as claimed in claim 2, wherein a protrusion is formed on the mounting arm.

13. The cable assembly as claimed in claim 1, further comprising a plurality of contacts supported by the insulative housing.

14. The cable assembly as claimed in claim 13, wherein the contacts are divided into a set of first contacts and a set of second contacts.

15. The cable assembly as claimed in claim 14, wherein mating portions of the first contacts are spaced apart mating portions of the second contacts along the front-to-back direction.

16. The cable assembly as claimed in claim 14, wherein mating portions of the first and second contacts and the optical module are disposed opposite sides of a tongue portion of the insulative housing.

17. A cable connector assembly comprising:
an elongated insulative housing defining opposite first and second faces in a vertical direction, and front and rear regions along a front-to-back direction perpendicular to said vertical direction;
the front region on the first face defining a recess to receive an optical module therein;
the rear region on the first face defining a plurality of channels;
a plurality of first conductive contacts each having a front mating section exposed upon the front region on the second face and a rear connecting section exposed in the corresponding channel to connect to a corresponding conductive wire;
a plurality of second conductive contacts each having a front mating portion exposed on the second face behind the front mating sections of the first contacts, and a rear connecting section exposed upon the rear region on the second face to connect to a conductive wire;
a plurality of optical fibers connected to a rear portion of the optical module and essentially extending along the first face; and
a one piece unitary biasing device including two abutment sections constantly forwardly abutting against the optical module, wherein
said two abutment sections are structurally spaced from each other with a distance in a transverse direction perpendicular to both said vertical direction and said front-to-back direction.

18. The cable connector assembly as claimed in claim 17, wherein said biasing device is attached to one of said optical module and said housing to result in self-deformation thereof during rearward movement of the optical module.

19. A cable connector assembly comprising:
an insulative housing defining opposite first and second faces in a vertical direction, and a mating port extending along a front-to-back direction perpendicular to said vertical direction;
a plurality of contacts having front contacting sections exposed upon the first face and rear connecting sections connected to corresponding conductive wires; and
an optical module being back and forth moveable along a recessed area of the second face, and including optical fibers extending rearwardly from a rear region of the optical module and along the second face; and
two abutment sections to constantly urge said optical module forwardly; wherein
said two abutment sections are structurally spaced from each other with a distance in a transverse direction perpendicular to both said vertical direction and said front-to-back direction, and essentially operatively independent from each other under condition that each of said two abutment sections includes one portion engaging the optical module, and another portion engaging the housing to constantly urge the optical module forwardly under condition that each abutment section is essentially attached to one of said optical module and said housing to result in self-deformation thereof during rearward movement of the optical module.

20. The cable connector assembly as claimed in claim 19, wherein said two abutments sections are unified with each other via a cap.
